(19) United States
(12) Patent Application Publication
(10) Pub. No.: US 2007/0189874 A1
(43) Pub. Date: Aug. 16, 2007

(54) Signal activated fastener array

(75) Inventor: Dickory Rudduck, Chicago, IL (US)

Correspondence Address: HEATHER AKARTSOUNES, 520 W. ERIE STREET, SUITE 210, CHICAGO, IL, 60610, US

(73) Assignee: Telezygology, Inc., Chicago (IL)

(21) Appl. No.: 10/598,950

(22) PCT Filed: Mar. 16, 2006
(86) PCT No.: PCT/AU05/00357

§ 371 Date: Sep. 15, 2006

(30) Foreign Application Priority Data
Mar. 16, 2004 (AU) 2004901367

(51) Int. Cl. F16B 31/00

(52) U.S. Cl. 411/1

(57) ABSTRACT

The invention provides a fastening system (40) which includes a plurality of fasteners (12). Each fastener (12) is adapted to be locked or unlocked upon receipt of a suitable signal, such as an electric, magnetic or infrared signal. The fasteners (12) are included in a single carrier (38).

### TECHNICAL FIELD

This invention relates to fasteners and in particular to multipoint fasteners.

### BACKGROUND ART

There have been disclosed in earlier patent specifications various types of fasteners, which may be actuated remotely (by radio frequency, infrared, etc.) or by hard wiring. The invention refers to any suitable prior art fastener. Some non-limiting examples are the fasteners disclosed in the following patent specifications, the contents of which are hereby imported herein by reference: Fixing and Release Systems: International Patent Application No. PCT/AU/99/00185, Improvements in Fixing and Release Systems: International Patent Application No. PCT/U/03/00759, Improvements in Assembly: International Patent Application No. PCT/AU/03/00933, Bolt Assembly: International Patent Application No. PCT/AU/03/01539, Fastener for Airbags and Other Uses: International Patent Application No. PCT/AU2004/000371, Fasteners: International Patent Application No. PCT/AU2004/001580.

### DISCLOSURE OF THE INVENTION

The invention provides a fastening system which includes two or more fasteners, each fastener adapted to be locked or unlocked upon receipt of a suitable signal, wherein the two or more fasteners are included in a single carrier.

The invention is based on the concept that many of the fasteners referred to above and in the specifications incorporated herein by reference can be provided in groups of fasteners. The fasteners may be arranged in a single plane, in two planes, or in three planes.

The fasteners in each carrier may be identical or they may differ one from another. When the fasteners are arranged in a single plane, they may adopt any desirable pattern. When the fasteners are arranged in two or three planes, there may be one or more fasteners in each plane. When there is more than one fastener in each plane, once again they may be arranged in any suitable pattern.

The fasteners may be adapted to be locked or unlocked upon receipt of the same signal, or different signals. For example, one fastener may be adapted to unlock upon receipt of a magnetic signal, whereas a neighbouring fastener in the carrier may be adapted to be unlocked upon receipt of an infrared signal.

The fasteners may be locked or unlocked upon receipt of the same type of signal, such as an electric signal, but the fasteners may be addressable individually as already disclosed in one or more of the specifications referred to above.

Preferably, all fasteners in a single carrier are connected to a single command source or there is a common electronic arrangement hosting all the fasteners. This can provide optimum efficiency and minimum cost in relation to groups of fasteners.

If desired, the fasteners in question may be the type where locking occurs without the need for activation of the fastener—for example, the type of fastener illustrated in FIGS. 5 to 7 of International Patent Application No. PCT/AU2004/001580. This type of fastener can greatly facilitate attachment of objects or parts to be fastened, yet provide the required security since release or unlocking is dependent on the receipt of a suitable signal.

As one example of application of the invention, the fastening system can be used to great effect in aircraft interiors where seats, shrouds, interior lining, etc., require a large number of fasteners. Using the fastening system of the invention can enable rapid exchange or replacement of these parts.

### BRIEF DESCRIPTION OF THE DRAWINGS

The invention will now be described in relation to certain non-limiting examples thereof described in connection with the accompanying drawings, in which:

FIG. 1 is a perspective view of a first embodiment of the invention;

FIG. 2 is a perspective view of a second embodiment of the invention;

FIG. 3 is a perspective view of a third embodiment of the invention; and

FIG. 4 is a perspective view of a fourth embodiment of the invention.

### DETAILED DESCRIPTION OF THE DRAWINGS

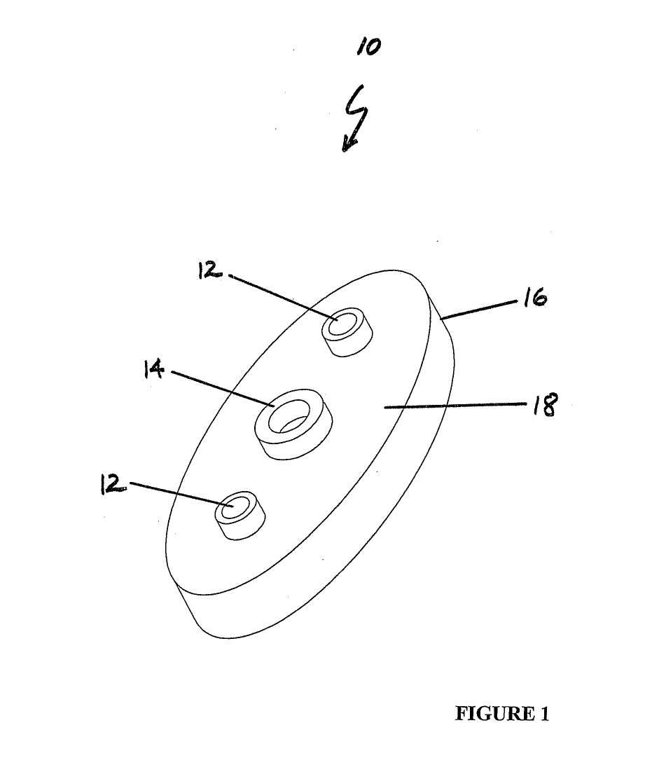

Turning first to FIG. 1, fastening system 10 has three fasteners, arranged in a straight line. The outer two fasteners 12 are of the same type. The centre fastener 14 is a different type from the outer two fasteners. The three fasteners are included in a single carrier 16 and lie on a single face 18. The fasteners may be chosen from any suitable type of fastener, including those discussed earlier.

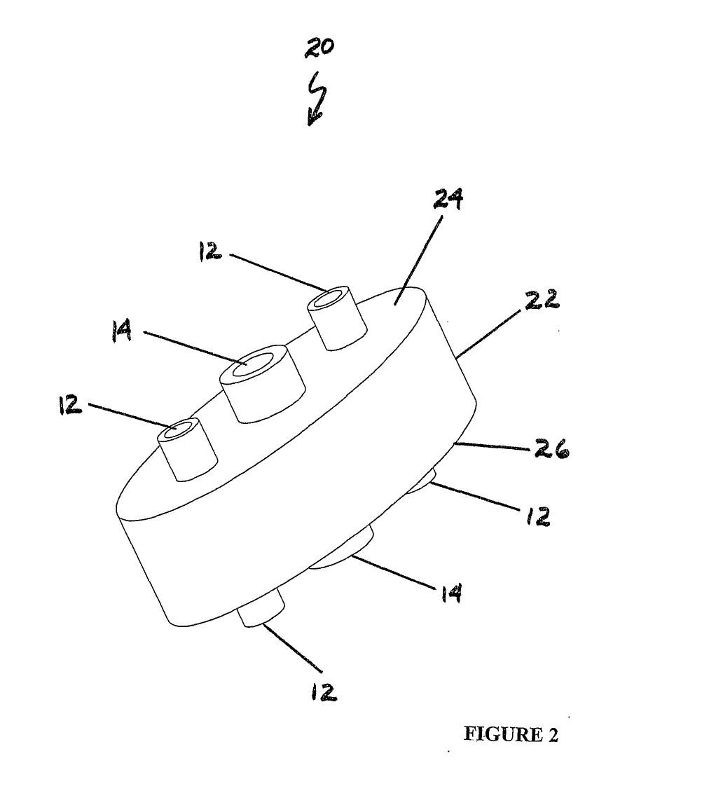

In relation to FIG. 2, fastening system 20 has fasteners on two faces, 24 and 26. Face 24 has three fasteners, two type-12 fasteners and one type-14 fastener, in a single row. Opposite face 26 of carrier 22 has an identical three fasteners.

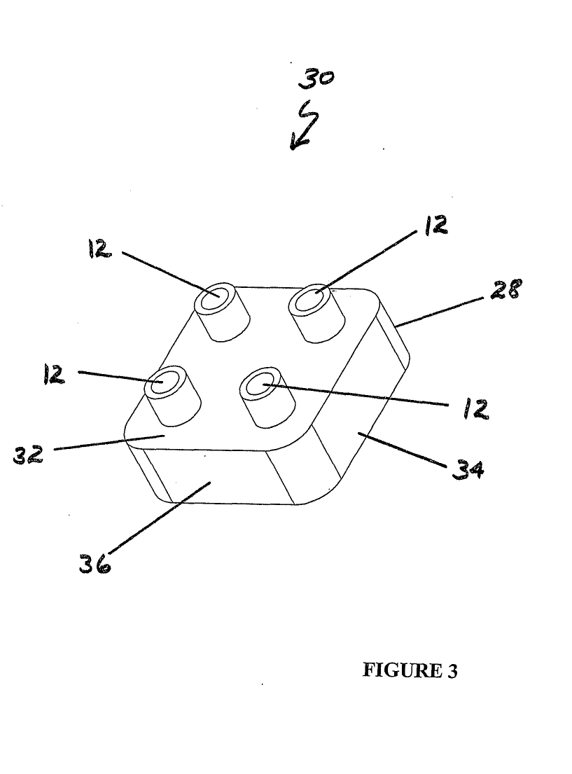

In FIG. 3, fastening system 30 has four type-12 fasteners arranged at the corners of a square on face 32. Carrier 28 in this embodiment has the fasteners on face 32 only. In a modified embodiment, carrier 28 could have fasteners on the face 20 opposite to face 32 or could carry one or more fasteners on, for example, faces 34 or 36. Fasteners on face 32 lie in one plane, while one or more fasteners on face 34, for example, would lie in a perpendicular plane to that on face 32.

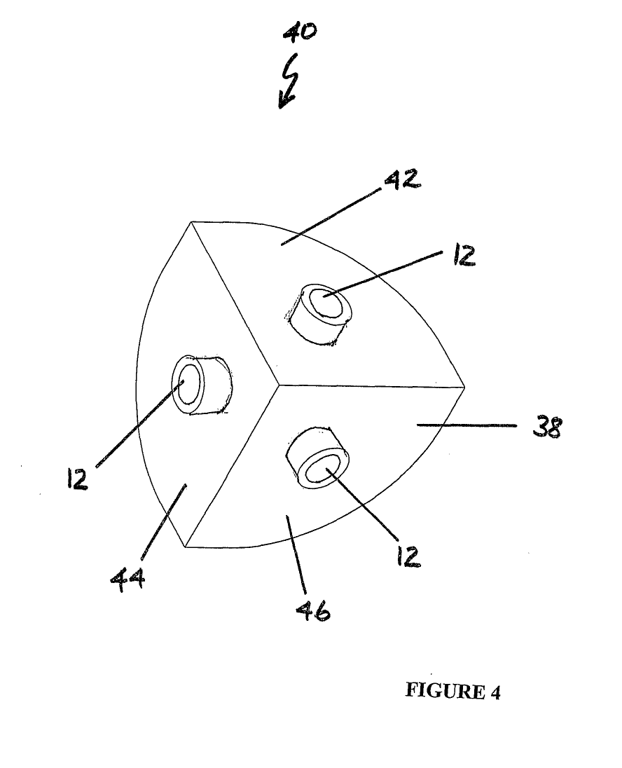

With reference to FIG. 4, fastening system 40 has three type-12 fasteners on carrier 38. One fastener 12 is on face 42, another fastener 12 is on face 44 and a third fastener 12 is on face 46. This illustrates an embodiment of the invention where the fasteners are in three planes.

As will be readily appreciated, the types of fasteners in the embodiments in FIGS. 1 to 4 may be readily mixed.

### INDUSTRIAL APPLICABILITY

The invention is useful in providing a carrier for a number of fasteners. It can assist in rapid fastening or unfastening in assemblies which require a large number of fasteners.

1. fastening system which includes two or more fasteners, each fastener adapted to be locked or unlocked upon receipt of a suitable signal, wherein the two or more fasteners are included in a single carrier having a plurality of faces, one of the fasteners being located on one of the faces and another of the fasteners being located on another of the faces.

2. The fastening system of claim 1, in which all fasteners are identical.

3. The fastening system of claim 1, which contains at least two different types of fasteners.

4. The fastening system of claim 1, wherein there are more than two fasteners.

5. The fastening system of claim 4, wherein the fasteners are located on three faces.

6. The fastening system of claim 5, wherein there is one fastener located on each face.

7. The fastening system of claim 5, wherein there is more than one fastener located on each face.

8. The fastening system of claim 5, wherein there is a mixture of faces having one fastener and more than one fastener.

9. The fastening system of claim 1, wherein each fastener is adapted to be locked or unlocked upon receipt of a signal of a first type.

10. The fastening system as claimed in claim 1, wherein at least one fastener is adapted to be locked or unlocked upon receipt of a signal of a first type and at least another fastener is adapted to be locked or unlocked upon receipt of a signal of a second type.

11. The fastening system as claimed in claim 10, wherein the signal of the first type and the signal of the second type is chosen from a group comprising a magnetic signal, an infrared signal and an electric signal.

12. The fastening system of claim 1, wherein each fastener has an individual address.

13. The fastening system of claim 1, wherein all fasteners are connected to a single command source for the suitable signal.

14. (canceled)
